(19) United States
(12) Patent Application Publication
(10) Pub. No.: US 2010/0020142 A1
(43) Pub. Date: Jan. 28, 2010

(54) REFILL INK AND INK CARTRIDGE

(76) Inventors: Akiko Bannai, Kanagawa (JP); Akihiko Gotoh, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/521,228

(22) PCT Filed: Dec. 26, 2007
(86) PCT No.: PCT/JP07/75395

§ 371 Date: Jun. 25, 2009

(30) Foreign Application Priority Data
Dec. 28, 2006 (JP) 2006-354490

(51) Int. Cl. B41J 2/175; C09D 11/02

(52) U.S. Cl. 347/86; 106/31.65

(57) ABSTRACT

A refill ink with which a used ink cartridge is to be refilled, including: a colorant, a wetting agent, and a surfactant, wherein in a mixed ink formed by mixing a residual ink remaining in the used ink cartridge and the refill ink at a volume ratio (residual ink:refill ink) of 1:1, the number A of coarse particles of 0.5 μm or greater in diameter measured immediately after the mixing and the number B of coarse particles of 0.5 μm or greater in diameter measured after the mixed ink has been left to stand at 25° C. and at RH of 50% for 24 hours satisfy the relationship B/A≦2.

### TECHNICAL FIELD

The present invention relates to a refill ink for ink-jet recording, which is excellent in storage stability and jet stability even when mixed with a residual ink that remains in an ink cartridge, and an ink cartridge refilled with the refill ink.

### BACKGROUND ART

Ink-jet printers have been rapidly becoming commonplace in recent years for their capability of recording onto plain paper and realizing easy color printing, compactness, inexpensiveness, and low running costs, etc. Along with such a rapid distribution of ink-jet printers, there is a rapid increase in the number of ink cartridges used. Since most of the ink cartridges are single-use ink cartridges, they present a serious problem that they cast a grave impact on the environment as wastes. Accordingly, makers have been searching for an efficient ink recovery method, but have enjoyed little success in terms of ink recovery rate. Thus, the current situation is that little progress is made in recycling collected cartridges.

Amongst such ink cartridges, those that have ink absorbers inside for forming negative pressure have a problem that since ink is poorly absorbed into the ink absorbers when refilled, uniform negative pressure cannot be obtained or ink spills out of the ink inlet. Also, there is a little ink remaining in the used ink cartridge, and when the remaining ink is not to be reused, it is necessary to provide an additional step of washing out the remaining ink.

Hitherto, there have been various proposals concerning refilling of an ink cartridge having an ink absorber inside.

For example, in Patent Literature 1, there is proposed a refilling method which focuses upon an ink remaining in an ink absorber inside an ink cartridge that is condensed by evaporation of a solvent. This proposal supposes refilling with an ink having the same composition.

In Patent Literature 2, as a method for recycling an ink tank, a process of washing an internal portion thereof is presented, and also a process of efficiently reusing a cartridge by judging whether or not the negative pressure retaining force of an ink absorber on the inside can be recycled is proposed. However, this proposal is not very advisable in view of the fact that a residual ink is not reused and a larger number of washing steps is required.

In Patent Literature 3, there is proposed a method of refilling an ink cartridge without causing ink to spill out of a filling opening, by curbing the occurrence of bubbles from an ink absorber inside the cartridge; however, this, too, merely solves a problem typical of a cartridge provided with an ink absorber.

In Patent Literature 4, there is proposed a refilling method which prevents a residual ink in a cartridge from being useless. In this proposal, a time-consuming step is required that involves measurements of the remaining amount of ink, constituents of a residual ink and the like by absorption spectroscopy and chromatography.

In Patent Literature 5, changes in quality or color are prevented by keeping in a certain range the difference in physical properties between a residual ink and a refill ink; however, the range of the difference is narrow, and so this disclosure is lacking in versatility.

As opposed to the proposals concerning dye-based inks, Patent Literatures 6, 7 and 8 can, for example, be mentioned as proposals which make it possible to replace dye inks with pigment inks. These proposals focus upon the pH or viscosity of both of dye-based and pigment inks, but the ranges of pH and viscosity are limited and so these proposals are lacking in versatility as well.

As described above, many refill inks are directed to dye inks, but refilling using pigment inks that are becoming popular these days has not yet been studied thoroughly, and in reality no effective measures have been taken as to how to reuse cartridges which have been used.

[Patent Literature 1] Japanese Patent Application Laid-Open (JP-A) No. 09-248919

[Patent Literature 2] JP-A No. 07-323560

[Patent Literature 3] Japanese Patent (JP-B) No. 3473253

[Patent Literature 4] JP-A No. 07-309017

[Patent Literature 5] JP-A No. 2002-121435

[Patent Literature 6] JP-A No. 2002-60665

[Patent Literature 7] JP-A No. 2005-320509

[Patent Literature 8] JP-A No. 2005-320531

### DISCLOSURE OF INVENTION

An object of the present invention is to provide a refill ink which is excellent in storage stability and jet stability even when mixed with a residual ink remaining in an ink cartridge, and an ink cartridge which makes it possible to decrease the number of ink cartridges discarded in huge numbers and reduce an environmental load by being refilled with the refill ink.

As a result of carrying out a series of earnest examinations in order to solve the problems, the present inventors found the following: regarding a refill ink which is reused in an ink-jet recording apparatus as a used ink cartridge is refilled with the refill ink, the refill ink can be excellent in storage stability and jet stability and used as a refill ink even when mixed with a residual ink that remains in the used ink cartridge, provided that the number of coarse particles in the mixed ink does not increase much.

The present invention is based upon the knowledge of the present inventors, and means for solving the problems are as follows.

<1> 1. A refill ink with which a used ink cartridge is to be refilled, including:

a colorant,

a wetting agent, and

a surfactant,

wherein in a mixed ink formed by mixing a residual ink remaining in the used ink cartridge and the refill ink at a volume ratio (residual ink:refill ink) of 1:1, the number A of coarse particles of 0.5 μm or greater in diameter measured immediately after the mixing and the number B of coarse particles of 0.5 μm or greater in diameter measured after the mixed ink has been left to stand at 25° C. and at RH of 50% for 24 hours satisfy the relationship B/A≦2.

As to the refill ink according to <1>, it is hoped that an ink having properties made as similar as possible to those of the residual ink remaining in the cartridge to be refilled will be used so as to match a recording system and to secure image quality, storage stability and jet stability. However, in order to produce refill inks that can correspond with recording systems of a wide variety of printers commonly used today, it is necessary to analyze constituents of residual inks and so forth, which is rather difficult.

What is most important about a refill ink is that it prevents clogging in a printer. To achieve this it is important to prevent the number of coarse particles from increasing at the time when the refill ink is mixed with a residual ink, and this can be achieved by preparing the mixed ink such that the number of coarse particles of 0.5 μm or greater in diameter measured after the mixed ink has been left to stand at 25° C. and at RH of 50% for 24 hours is not over twice as large as the number of coarse particles measured immediately after the mixing.

<2> The refill ink according to <1>, wherein the viscosity (C) of the mixed ink at 25° C. before stored and the viscosity (D) of the mixed ink at 25° C. after stored at 25° C. and at RH of 50% for one week satisfy the relationship D/C≦2.

As to the refill ink according to <2>, since the jet amount and jet velocity of the mixed ink vary according to the viscosity thereof, it is thought probable that the larger the difference in property between the refill ink and the residual ink becomes, the lower image quality becomes. Accordingly, it is desirable that the properties of the refill ink be also made as similar as possible to those of the residual ink; however, provided that the mixed ink is not thickened when left to stand for one week after the mixing, there is a low risk of causing clogging, and so the refill ink can be used as a refill ink without causing changes in its properties.

<3> The refill ink according to any one of claims 1 and 2, wherein the volume average particle diameter (E) of the mixed ink before stored and the volume average particle diameter (F) of the mixed ink after stored at 25° C. and at RH of 50% for one week satisfy the relationship F/E≦1.5.

As to the refill ink according to <3>, since the jet amount and jet velocity of the mixed ink vary according to the volume average particle diameter thereof, it is thought probable that the larger the difference in property between the refill ink and the residual ink becomes, the lower image quality becomes. Accordingly, it is desirable that the properties of the refill ink be also made as similar as possible to those of the residual ink; however, provided that the average particle diameter of the mixed ink is not increased when the mixed ink is left to stand for one week after the mixing, there is a low risk of causing clogging, and so the refill ink can be used as a refill ink without its properties being altered.

<4> The refill ink according to any one of <1> to <3>, wherein the content X of divalent metal ions in the refill ink and the content Y of divalent metal ions in the residual ink satisfy the relationship 1<X/Y≦5.

As to the refill ink according to <4>, there are various possible mechanisms by which pigment ink particles aggregate, but they are difficult to identify; one possible cause for this is the amount of multivalent metal ions. As the degree of purification of ink increases, so too does its reliability, but costs thereby increase. In the present invention, jet reliability is secured by adjusting the amount of multivalent metal ions contained in the refill ink in such a manner as to become greater than one time and not over five times the amount of multivalent metal ions contained in the residual ink; in particular, it is important to adjust the amount of divalent metal ions contained in the refill ink.

<5> An ink cartridge including: a container; and the refill ink according to any one of <1> to <4>, with which the container is refilled.

The ink cartridge according to <5> makes it possible to prevent ink cartridges from being discarded in huge numbers and reduce an environmental load by being refilled with the refill ink of the present invention.

<6> The ink cartridge according to <5>, wherein the ink cartridge comprises no ink absorber therein.

### BRIEF DESCRIPTION OF DRAWINGS

FIG. 1 shows one example of an ink cartridge of the present invention.

FIG. 2 shows the ink cartridge of FIG. 1 with the inclusion of a case.

### BEST MODE FOR CARRYING OUT THE INVENTION

### Refill Ink

A refill ink of the present invention is a refill ink with which a used ink cartridge is to be refilled, containing at least a colorant, a wetting agent and a surfactant, also containing a penetrant, and further containing additional constituents according to necessity.

According to the present invention, in a mixed ink formed by mixing a residual ink remaining in the used ink cartridge and the refill ink at a volume ratio (residual ink:refill ink) of 1:1, the number A of coarse particles of 0.5 μm or greater in diameter measured immediately after the mixing and the number B of coarse particles of 0.5 μm or greater in diameter measured after the mixed ink has been allowed to stand at 25° C. and at RH of 50% for 24 hours satisfy the relationship B/A≦2, preferably B/A≦1.5, more preferably 0.5≦B/A≦1.2. When B/A exceeds 2, a filter becomes liable to clogging, and thus the jet stability of the mixed ink may be impaired.

As used herein the phase “immediately after the mixing” means within 30 minutes after the residual ink and the refill ink have been mixed.

It is desirable that there be a small number of coarse particles in the refill ink, more desirably the number of coarse particles is in the range of 30,000 to 500,000.

Here, the number of coarse particles of 0.5 μm or greater in diameter can be measured using ACCUSIZER 780 (manufactured by Particle Sizing Systems, Inc.), for example.

Also, in a mixed ink formed by mixing a residual ink remaining in a used ink cartridge and a refill ink at a volume ratio (residual ink:refill ink) of 1:1, the viscosity (C) of the mixed ink at 25° C. before stored and the viscosity (D) of the mixed ink at 25° C. after stored at 25° C. and at RH of 50% for one week preferably satisfy the relationship D/C≦2, more preferably D/C≦1.5, even more preferably 0.8≦D/C≦1.2. When D/C exceeds 2, the viscosity becomes so high that the jet force of a head becomes insufficient; for this reason, jet stability may be impaired or droplets jetted may decrease in amount, and thus there may be a decrease in image density.

As used herein the phrase “before stored” means within 30 minutes after the residual ink and the refill ink have been mixed.

The viscosity (C) of the refill ink at 25° C. preferably stands at the viscosity of a residual (exclusively made) ink ±2 mPa·s, more preferably the viscosity of the residual (exclusively made) ink 1 mPa·s.

Here, the viscosity can be measured using RL-500 manufactured by Toki Sangyo Co., Ltd, for example.

Also, in a mixed ink formed by mixing a residual ink remaining in a used ink cartridge and a refill ink at a volume ratio (residual ink:refill ink) of 1:1, the volume average particle diameter (E) of the mixed ink at 25° C. before stored and the volume average particle diameter (E) of the mixed ink at 25° C. after stored at 25° C. and at RH of 50% for one week preferably satisfy the relationship F/E≦1.5, more preferably F/E≦1.3, even more preferably 0.9≦F/E≦1.2. When F/E exceeds 1.5, there may be a decrease in jet stability.

As used herein the phrase “before stored” means within 30 minutes after the residual ink and the refill ink have been mixed.

It is desirable that the volume average particle diameter of the refill ink be 10 nm to 200 nm, more desirably 30 nm to 150 nm.

Here, the volume average particle diameter can be measured using MICROTRAC UPA150 manufactured by Nikkiso Co., Ltd., for example.

The content X of divalent metal ions in the refill ink and the content Y of divalent metal ions in a residual ink preferably satisfy the relationship 1<X/Y≦5, more preferably 1<X/Y≦3, even more preferably 1<X/Y≦2. When X/Y exceeds 5, the colorant flocculates, and thus jet failure may be caused.

The content of divalent metal ions in the refill ink preferably amounts to 1 ppm to 50 ppm. Additionally, examples of the divalent metal ions include Ca²⁺, Mg²⁺ and Ba²⁺.

Here, the content of divalent metal ions in the ink can be measured by ion chromatography or the like, for example.

The refill ink of the present invention is not particularly limited and can be suitably selected according to the purpose as long as it is furnished with the aforesaid characteristics; however, as described above, the refill ink contains at least a colorant, a wetting agent and a surfactant, also contains a penetrant, and further contains additional constituents according to necessity. The following explains constituents of the ink.

### —Colorant—

Pigments can be suitably used for the colorant. The pigments may be inorganic pigments or organic pigments.

Examples of the inorganic pigments include titanium oxide, iron oxide, calcium carbonate, barium sulfate, aluminum hydroxide, barium yellow, cadmium red, chrome yellow, carbon blacks, Prussian blue and metal powder. Amongst these, carbon blacks and the like are preferable. Examples of the carbon blacks include a carbon black produced by a known process such as a contact process, furnace process or thermal process.

Examples of the organic pigments include azo pigment, polycyclic pigment, dye chelate, nitro pigment, nitroso pigment and aniline black. Amongst these, azo pigment, polycyclic pigment and the like are preferable. Examples of the azo pigment include azo lake, insoluble azo pigment, condensed azo pigment and chelate azo pigment. Examples of the polycyclic pigment include phthalocyanine pigment, perylene pigment, perinone pigment, anthraquinone pigment, quinacridone pigment, dioxazine pigment, indigo pigment, thioindigo pigment, isoindolinone pigment, quinophthalone pigment, azomethine-based pigment and Rhodamine B Lake pigment. Examples of the dye chelate include basic dye chelate and acid dye chelate.

The colors of the pigments are not particularly limited and can be suitably selected according to the purpose; examples of the pigments in relation to colors include pigments for black and pigments for colors other than black. These pigments may be used alone or in combination.

Examples of the pigments for black include carbon blacks (C. I. Pigment Black 7) such as furnace black, lamp black, acetylene black and channel black; metals such as copper, iron (C. I. Pigment Black 11) and titanium oxide; and organic pigments such as aniline black (C. I. Pigment Black 1).

Carbon blacks used for the black pigment inks are preferably carbon blacks produced by a furnace process or a channel process.

Such carbon blacks are not particularly limited and can be suitably selected according to the purpose; examples thereof include No. 2,300, No. 900, MCF-88, No. 33, No. 40, No. 45, No. 52, MA7, MA8, MA100 and No. 2,200B (all of which are produced by Mitsubishi Chemical Corporation); RAVEN 700, RAVEN 5,750, RAVEN 5,250, RAVEN 5,000, RAVEN 3,500 and RAVEN 1,255 (all of which are produced by Columbian Chemicals Company); REGA 1,400R, REGA 330R, REGA 660R, MOGUL L, MONARCH 700, MONARCH 800, MONARCH 880, MONARCH 900, MONARCH 1,000, MONARCH 1,100, MONARCH 1,300 and MONARCH 1,400 (all of which are produced by Cabot Corporation); COLOR BLACK FW1, COLOR BLACK FW2, COLOR BLACK FW2V, COLOR BLACK FW18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A and SPECIAL BLACK 4 (all of which are produced by Evonik Degussa GmbH); and BONJET CW-1 (produced by Orient Chemical Industries, Ltd.).

Amongst the pigments for colors other than black, pigments for yellow inks are not particularly limited and can be suitably selected according to the purpose; examples thereof include C. I. Pigment Yellows 1 (Fast Yellow G), 2, 3, 12 (Disazo Yellow AAA), 13, 14, 16, 17, 23, 24, 34, 35, 37, 42 (yellow iron oxide), 53, 55, 73, 74, 75, 81, 83 (Disazo Yellow HR), 93, 95, 97, 98, 100, 101, 104, 108, 109, 110, 114, 117, 120, 128, 129, 138, 150, 151, 153 and 154.

Pigments for magenta are not particularly limited and can be suitably selected according to the purpose; examples thereof include C. I. Pigment Reds 1, 2, 3, 5, 7, 12, 17, 22 (Brilliant Fast Scarlet), 23, 31, 38, 48:2 (Permanent Red 2B(Ba)), 48:2 (Permanent Red 2B (Ca)), 48:3 (Permanent Red 2B (Sr)), 48:4 (Permanent Red 2B (Mn)), 49:1, 52:2, 53:1, 57:1 (Brilliant Carmine 6B), 60:1, 63:1, 63:2, 64:1, 81 (Rhodamine 6G Lake), 83, 88, 92, 101 (red ochre), 104, 105, 106, 108 (cadmium red), 112, 114, 122 (dimethylquinacridone), 123, 146, 149, 166, 168, 170, 172, 177, 178, 179, 184, 185, 190, 193, 202, 209 and 219.

Pigments for cyan are not particularly limited and can be suitably selected according to the purpose; examples thereof include C. I. Pigment Blues 1, 2, 3, 15 (Copper Phthalocyanine Blue R), 15:1, 15:2, 15:3 (Phthalocyanine Blue G), 15:4, 15:6 (Phthalocyanine Blue E), 15:34, 16, 17:1, 22, 56, 60 and 63; and C. 1. vat blues 4 and 60.

Pigments for neutral colors are not particularly limited and can be suitably selected according to the purpose; examples of pigments for red, green and blue include C. I. Pigment Reds 177, 194 and 224; C. I. Pigment Orange 43; C. I. Pigment Violets 3, 19, 23 and 37; and C. I. Pigment Greens 7 and 36.

Also, suitable examples of the pigments include a pigment whose surface is modified such that at least one kind of hydrophilic group is bonded to the surface of the pigment directly or via another atom group (sometimes referred to as “self-dispersing pigment”). In this case, a method of chemically bonding a certain functional group (a functional group such as a sulfone group or carboxyl group) to the surface of pigment, or a method of subjecting the surface to wet oxidation with the use of at least either a hypohalous acid or a salt thereof is employed, for example. In particular, the form in which a carboxyl group is bonded to the surface of a pigment dispersed in water is particularly favorable. Since the surface of the pigment is modified such that a carboxyl group is bonded thereto, not only does dispersion stability improve, but also high printing quality can be obtained and the water resistance of a recording medium after printing improves further.

Superior in redispersibility after dried, an ink containing the self-dispersing pigment does not cause clogging even when printing has stopped being conducted for a long time and a water content of the ink in the vicinity of a nozzle of an ink-jet head has evaporated, and thus the ink easily enables favorable printing with a simple cleaning operation. Such a self-dispersing pigment creates a particularly great synergy effect and makes it possible to obtain high-quality images that are even more reliable, when combined with the after-mentioned surfactants and penetrants.

Besides pigments of the above-mentioned form, it is also possible to use a polymer emulsion in which a color material that is insoluble or sparingly soluble in water is contained in polymer particles. As used herein the phrase “a polymer emulsion in which a color material is contained” means a polymer emulsion in which a color material is encapsulated in polymer particles and/or a polymer emulsion in which a color material is adsorbed onto the surface of polymer particles. In this case, it is not that the whole color material needs to be encapsulated or adsorbed, but that the color material may be dispersed in the emulsion to such an extent that the effects of the present invention are not impaired. The color material is not particularly limited and can be suitably selected according to the purpose as long as it is insoluble or sparingly soluble in water and able to be contained in the polymer; examples thereof include dyes such as oil-soluble dyes and dispersive dyes, and the pigments mentioned as the specific examples. Amongst these, use of the pigments is preferable in terms of the light resistance of recorded materials to be obtained.

Examples of the polymer which forms the polymer emulsion include vinyl polymers, polyester polymers and polyurethane polymers; amongst these, vinyl polymers and polyester polymers are particularly preferable.

Further, a pigment dispersed into an aqueous medium by means of a dispersant can be additionally used. A known dispersant used to prepare a conventionally known pigment dispersion solution can be applied to the dispersant; examples thereof include polyacrylic acid, polymethacrylic acid, acrylic acid-acrylonitrile copolymer, vinyl acetate-acrylic acid ester copolymer, acrylic acid-acrylic acid alkyl ester copolymer, styrene-acrylic acid copolymer, styrene-methacrylic acid copolymer, styrene-acrylic acid-acrylic acid alkyl ester copolymer, styrene-methacrylic acid-acrylic acid alkyl ester copolymer, styrene-α-methylstyrene-acrylic acid copolymer, styrene-α-methylstyrene-acrylic acid copolymer-acrylic acid alkyl ester copolymer, styrene-maleic acid copolymer, vinylnaphthalene-maleic acid copolymer, vinyl acetate-ethylene copolymer, vinyl acetate-fatty acid vinylethylene copolymer, vinyl acetate-maleic acid ester copolymer, vinyl acetate-crotonic acid copolymer and vinyl acetate-acrylic acid copolymer.

It is desirable that the mass-average molecular mass of the dispersant be 3,000 to 50,000, more desirably 5,000 to 30,000, even more desirably 7,000 to 15,000.

The dispersant is suitably added to such an extent that a pigment is stably dispersed and other effects of the present invention are not lost, and it is desirable that the additive amount thereof be 1:0.06 to 1:3 in mass ratio (pigment dispersant), more desirably 1:0.125 to 1:3.

It is desirable that a carboxyl group be bonded to the dispersant. When a carboxyl group is bonded to a dispersant, not only does dispersion stability improve, but also high printing quality can be obtained and the water resistance of a recording medium after printing improves further. Moreover, the effect of preventing offsetting of the printed letters/characters can be obtained. In particular, when a pigment dispersed by means of a dispersant to which a carboxyl group is bonded is used together with a penetrant, a sufficient drying rate can be obtained and such an effect can be obtained that offsetting is reduced, even in the case where a recording medium which is relatively large in size such as plain paper is printed. It is inferred that this is due to the fact that since the dissociation constant of carboxylic acids is smaller than that of other acid radicals, the solubility of the dispersant itself lowers as the pH value of the ink lowers and the carboxylic acids interact with multivalent metal ions such as a calcium ion that are present in the vicinity of the recording medium surface, after the pigment has been attached to the recording medium, and thus the dispersant itself and the pigment flocculate.

Besides the pigments, the following dyes can be employed as the colorant.

The water-soluble dyes are dyes classified into acid dyes, direct dyes, basic dyes, reactive dyes and edible dyes according to the color index, preferably ones which are superior in water resistance and light resistance.

Examples of the acid dyes and the edible dyes include C. I. Acid Yellows 17, 23, 42, 44, 79 and 142; C. I. Acid Reds 1, 8, 13, 14, 18, 26, 27, 35, 37, 42, 52, 82, 87, 89, 92, 97, 106, 111, 114, 115, 134, 186, 249, 254 and 289; C. I. Acid Blues 9, 29, 45, 92 and 249; C. I. Acid Blacks 1, 2, 7, 24, 26 and 94; C. I. Food Yellows 3 and 4; C. I. Food Reds 7, 9 and 14; and C. I. Food Blacks 1 and 2.

Examples of the direct dyes include C. I. Direct Yellows 1, 12, 24, 26, 33, 44, 50, 86, 120, 132, 142 and 144; Direct Reds 1, 4, 9, 13, 17, 20, 28, 31, 39, 80, 81, 83, 89, 225 and 227; C. I. Direct Oranges 26, 29, 62 and 102; C. I. Direct Blues 1, 2, 6, 15, 22, 25, 71, 76, 79, 86, 87, 90, 98, 163, 165, 199 and 202; and C. I. Direct Blacks 19, 22, 32, 38, 51, 56, 71, 74, 75, 77, 154, 168 and 171.

Examples of the basic dyes include C. I. Basic Yellows 1, 2, 11, 13, 14, 15, 19, 21, 23, 24, 25, 28, 29, 32, 36, 40, 41, 45, 49, 51, 53, 63, 64, 65, 67, 70, 73, 77, 87 and 91; C. I. Basic Reds 2, 12, 13, 14, 15, 18, 22, 23, 24, 27, 29, 35, 36, 38, 39, 46, 49, 51, 52, 54, 59, 68, 69, 70, 73, 78, 82, 102, 104, 109 and 112; C. I. Basic Blues 1, 3, 5, 7, 9, 21, 22, 26, 35, 41, 45, 47, 54, 62, 65, 66, 67, 69, 75, 77, 78, 89, 92, 93, 105, 117, 120, 122, 124, 129, 137, 141, 147 and 155; and C. I. Basic Blacks 2 and 8.

Examples of the reactive dyes include C. I. Reactive Blacks 3, 4, 7, 11, 12 and 17; C. I. Reactive Yellows 1, 5, 11, 13, 14, 20, 21, 22, 25, 40, 47, 51, 55, 65 and 67; C. I. Reactive Reds 1, 14, 17, 25, 26, 32, 37, 44, 46, 55, 60, 66, 74, 79, 96 and 97; and C. I. Reactive Blues 1, 2, 7, 14, 15, 23, 32, 35, 38, 41, 63, 80 and 95.

It is desirable that the average particle diameter of a pigment used in the ink be in the range of 10 nm to 200 nm. As used herein the term “average particle diameter” denotes a value of average particle diameter measured at a cumulative percentage of 50% in the volume-based particle size distribution. To measure a value of average particle diameter at a cumulative percentage of 50% in the volume-based particle size distribution, it is possible to use, for example, a method referred to as “dynamic light scattering method (Doppler scattered light analysis)” in which a particle undergoing Brownian motion in an ink is irradiated with laser light, and the particle diameter is calculated from the variation of the frequency (light frequency) of the light (backscattered light) returning from the particle.

When the average particle diameter is smaller than 10 nm, dispersion stability in the ink is impaired, and the image density at the time of printing becomes inferior as a result. In addition, there will be another problem in which microparticulation of the pigment to that level is costly. Conversely, when the average particle diameter is greater than 200 nm, the fixation properties of images become inferior, flocculation is liable to arise during a long period of storage, and thus clogging is liable to arise.

The content of the colorant in the ink is not particularly limited and can be suitably selected according to the purpose; however, it is preferably 0.5% by mass to 15% by mass, more preferably 5% by mass to 12% by mass.

### —Wetting Agent—

The wetting agent is not particularly limited and can be suitably selected according to the purpose; examples thereof include multivalent alcohols, multivalent alcohol alkyl ethers, multivalent alcohol aryl ethers, nitrogen-containing heterocyclic compounds, amides, amines, sulfur-containing compounds, propylene carbonate and ethylene carbonate. These may be used alone or in combination. Amongst these, multivalent alcohol alkyl ethers and multivalent alcohol aryl ethers are particularly preferable. Inclusion of such wetting agents makes it possible to prevent a water content of an ink from evaporating, more favorably prevent curb deposition of a colorant at an ink-jet orifice and jet failure caused by a rise in viscosity, and thus provide a pigment ink which is high in jet reliability.

Examples of the multivalent alcohols include ethylene glycol, diethylene glycol, triethylene glycol, polyethylene glycol, polypropylene glycol, 1,3-propanediol, 1,3-butanediol, 1,4-butanediol, 3-methyl-1,3-butanediol, 1,5-pentanediol, 1,6-hexanediol, glycerol, 1,2,6-hexanetriol, 1,2,4-butanetriol, 1,2,3-butanetriol and petriol.

Examples of the multivalent alcohol alkyl ethers include ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether and propylene glycol monoethyl ether.

Examples of the multivalent alcohol aryl ethers include ethylene glycol monophenyl ether and ethylene glycol monobenzyl ether.

Examples of the nitrogen-containing heterocyclic compounds include N-methyl-2-pyrrolidone, N-hydroxyethyl-2-pyrrolidone, 2-pyrrolidone, 1,3-dimethylimidazolidinone and ε-caprolactam.

Examples of the amides include formamide, N-methylformamide and N,N-dimethylformamide.

Examples of the amines include monoethanolamine, diethanolamine, triethanolamine, monoethylamine, diethylamine and triethylamine.

Examples of the sulfur-containing compounds include dimethylsulfoxide, sulfolane and thiodiethanol.

Amongst these, glycerin, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,3-propanediol, 1,5-pentanediol, tetraethylene glycol, 1,6-hexanediol, 2-methyl-2,4-pentanediol, polyethylene glycol, 1,2,4-butanetriol, 1,2,6-hexanetriol, thiodiglycol, 2-pyrrolidone, N-methyl-2-pyrrolidone and N-hydroxyethyl-2-pyrrolidone are preferable, with glycerin, 3-methyl-1,3-butanediol and 2-pyrrolidone being particularly preferable, in that it is possible to obtain superior effects on solubility and prevention of jet characteristic failure caused by evaporation of a water content.

It is desirable that the content of the wetting agent in the ink be 5% by mass to 30% by mass, more desirably 10% by mass to 30% by mass. When the content is less than 5% by mass, the effects given by adding the wetting agent are insufficient; when the content is greater than 30% by mass, the viscosity of the aqueous ink becomes high, thus possibly affecting jet stability.

### —Surfactant—

The surfactant is not particularly limited and can be suitably selected according to the purpose; examples thereof include anionic surfactants, nonionic surfactants, ampholytic surfactants, fluorine-based surfactants and silicone-based surfactants. Addition of such surfactants makes it possible to obtain high-quality images with enhanced penetrativeness to paper and rapid drying properties, in which the bleeding of letters/characters and boundaries is further reduced.

Examples of the anionic surfactants include polyoxyethylene alkyl ether acetate, dodecylbenzene sulfonate, laurate and salts of polyoxyethylene alkyl ether sulfate.

Examples of the nonionic surfactants include acetylene glycol-based surfactants, polyoxyethylene alkyl ether, polyoxyethylene alkyl phenyl ether, polyoxyethylene alkyl ester and polyoxyethylene sorbitan fatty acid ester.

Examples of the acetylene glycol-based surfactants include 2,4,7,9-tetramethyl-5-decyne-4,7-diol, 3,6-dimethyl-4-octine-3,6-diol and 3,5-dimethyl-1-hexyne-3-ol. Examples of the acetylene glycol-based surfactants as commercially-supplied products include SURFYNOLs 104, 82, 465, 485 and TG produced by Air Products and Chemicals, Inc. (USA).

Examples of the ampholytic surfactants include laurylamino propionate, lauryldimethylbetaine, stearyldimethylbetaine and lauryldihydroxyethylbetaine. Specific examples thereof include lauryl dimethyl amine oxide, myristyl dimethyl amine oxide, stearyl dimethyl amine oxide, dihydroxy ethyl lauryl amine oxide, polyoxyethylene coconut oil alkyldimethyl amine oxide, dimethylalkyl (coconut) betaine and dimethyllaurylbetaine.

Amongst the surfactants, nonionic surfactants and anionic surfactants are preferable, and polyoxyethylene alkyl ether-based surfactants and polyoxyethylene alkyl ether acetate-based surfactants are particularly preferable. These may be used alone or in combination. When a single surfactant is sparingly soluble in a recording solution, it can be made soluble by being mixed with other surfactant(s) to exist stably. Additionally, it is desirable that inorganic salts produced as by-products when surfactants are synthesized be purified by an ion-exchange resin and removed.

Suitable examples of commercially-supplied surfactants include the BT series obtainable from Nikko Chemicals Co., Ltd., the SOFTANOL series obtainable from Nippon Shokubai Co., Ltd., DISPANOL obtainable from NOF Corporation, the NIKKOL ETC series and the NIKKOL AKYPO series obtainable from Nikko Chemicals Co., Ltd. and the BEAULIGHT series obtainable from Sanyo Chemical Industries, Ltd.

In order to improve image quality further, it is desirable to use fluorine-based surfactants or silicone-based surfactants with great penetrativeness, with fluorine-based surfactants being particularly desirable.

The silicone-based surfactants are not particularly limited and can be suitably selected according to the purpose, preferably ones that do not decompose even at high pH values; examples thereof include side-chain-modified polydimethylsiloxane, both-terminal-modified polydimethylsiloxane, either-terminal-modified polydimethylsiloxane and side-chain-both-terminal-modified polydimethylsiloxane. Amongst these, ones having polyoxyethylene groups or polyoxyethylenepolyoxypropylene groups as modification groups are particularly preferable in that they exhibit favorable characteristics as aqueous surfactants.

As such surfactants, suitably synthesized surfactants or commercially-supplied surfactants may be used. The commercially-supplied surfactants can be easily obtained from BYK Additives & Instruments, Shin-Etsu Chemical Co., Ltd. and Dow Corning Toray Co., Ltd., for example.

Examples of the fluorine-based surfactants include perfluoroalkyl sulfonic acid compounds, perfluoroalkyl carboxylic compounds, perfluoroalkyl phosphoric acid ester compounds, perfluoroalkyl ethylene oxide adducts, and polyoxyalkylene ether polymer compounds having perfluoroalkylether groups as side chains. Amongst these, polyoxyalkylene ether polymer compounds having perfluoroalkylether groups as side chains are particularly preferable because they are low in foaming property and also in the bioaccumulation potential of fluorine compounds that is deemed to be a problem these days and are therefore safe.

Examples of the perfluoroalkyl sulfonic acid compounds include perfluoroalkyl sulfonic acids and perfluoroalkyl sulfonates.

Examples of the perfluoroalkyl carboxylic compounds include perfluoroalkyl carboxylic acids and perfluoroalkyl carboxylates.

Examples of the perfluoroalkyl phosphoric acid ester compounds include perfluoroalkyl phosphoric acid esters and salts of perfluoroalkyl phosphoric acid esters.

Examples of the polyoxyalkylene ether polymer compounds having perfluoroalkylether groups as side chains include polyoxyalkylene ether polymers having perfluoroalkylether groups as side chains, sulfuric acid ester salts of polyoxyalkylene ether polymers having perfluoroalkylether groups as side chains, and salts of polyoxyalkylene ether polymers having perfluoroalkylether groups as side chains.

Examples of counterions for salts in these fluorine-based surfactants include Li, Na, K, NH₄, NH₃CH₂CH₂OH, NH₂(CH₂CH₂OH)₂ and NH(CH₂CH₂OH)₃.

As the fluorine-based surfactants, suitably synthesized surfactants or commercially-supplied surfactants may be used.

Examples of the commercially-supplied surfactants include SURFLONs S-111, S-112, S-113, S-121, S-131, S-132, S-141 and S-145 (all of which are produced by Asahi Glass Co., Ltd.), FLUORADs FC-93, FC-95, FC-98, FC-129, FC-135, FC-170C, FC-430 and FC-431 (all of which are produced by Sumitomo 3M Limited), MEGAFACs F-470, F-1405 and F-474 (all of which are produced by Dainippon Ink And Chemicals, Incorporated), ZONYLs TBS, FSP, FSA, FSN-100, FSN, FSO-100, FSO, FS-300 and UR (all of which are produced by E. I. du Pont de Nemours and Company), FT-110, FT-250, FT-251, FT-400S, FT-150 and FT-400SW (all of which are produced by Neos Company Limited), and PF-151N (produced by OMNOVA Solutions Inc.). Amongst these, ZONYLs FS-300, FSN, FSN-100 and FSO (all of which are produced by E. I. du Pont de Nemours and Company) are particularly preferable in that they are excellent in reliability and coloring improvement.

It is desirable that the content of the surfactant in the ink be 0.01% by mass to 5.0% by mass, more desirably 0.5% by mass to 3% by mass. When the content is less than 0.01% by mass, the addition of the surfactant is not effective; when the content is greater than 5.0% by mass, penetrativeness to a recording medium becomes greater than necessary, and so there may be a decrease in image density or offsetting may arise.

### —Penetrant—

For the penetrant, a polyol compound, a glycol ether compound or the like is used; in particular, at least either a polyol compound or glycol ether compound having eight or more carbon atoms is suitable.

When the polyol compound has fewer than eight carbon atoms, a recording medium may be stained at the time of double-side printing because of insufficient penetrativeness, and an image may be poorly filled with image elements or dots because ink does not sufficiently spread over the recording medium, so that there may be a decrease in letter/character quality and image density.

Suitable examples of the polyol compound having eight or more carbon atoms include 2-ethyl-1,3-hexanediol and 2,2,4-trimethyl-1,3-pentanediol.

The glycol ether compound is not particularly limited and can be suitably selected according to the purpose. Examples thereof include multivalent alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether and propylene glycol monoethyl ether; and multivalent alcohol aryl ethers such as ethylene glycol monophenyl ether and ethylene glycol monobenzyl ether.

The additive amount of the penetrant to the ink is not particularly limited and can be suitably selected according to the purpose; however, it is preferably 0.1% by mass to 20% by mass, more preferably 0.5% by mass to 10% by mass.

### —Antifoaming Agent—

An antifoaming agent may be added to the ink of the present invention. Silicone-based antifoaming agents, many of which are particularly superior in foam-breaking effect, are classified into oil type, compound type, self-emulsification type, emulsion type and the like; when use thereof in an aqueous system is considered, use of the self-emulsification type or the emulsion type is preferable in that reliability is secured. Also, modified silicone-based antifoaming agents such as amino-modified antifoaming agents, carbinol-modified antifoaming agents, methacryl-modified antifoaming agents, polyether-modified antifoaming agents, alkyl-modified antifoaming agents, higher fatty acid ester modified antifoaming agents and alkylene oxide modified antifoaming agents may be used.

The additive amount of the antifoaming agent is not particularly limited and can be suitably selected according to the purpose; however, it is preferably 0.001% by mass to 3% by mass, more preferably 0.05% by mass to 0.5% by mass.

Examples of available commercially-supplied antifoaming agents include silicone antifoaming agents (such as KS-508, KS-531, KM-72 and KM-85) produced by Shin-Etsu Chemical Co., Ltd., silicone antifoaming agents (such as Q2-3183A and SH5510) produced by Dow Corning Toray Co., Ltd., silicone antifoaming agents (such as SAG30) produced by Nippon Unicar Company Limited, and antifoaming agents (such as the ADEKANATE series) produced by Adeka Corporation.

### —Additional Constituents—

The additional constituents are not particularly limited and can be suitably selected according to necessity; examples thereof include a pH adjuster, a preservative/antimold agent, an anticorrosive, an antioxidant, an ultraviolet absorber, an oxygen absorber and a light stabilizer.

Examples of the preservative/antimold agent include 1,2-benzisothiazolin-3-one, sodium dehydroacetate, sodium sorbate, 2-pyridinethiol-1-sodium oxide, sodium benzoate and sodium pentachlorophenol.

The pH adjuster is not particularly limited as long as it can adjust the pH of the prepared ink to 7 or greater without adversely affecting it, and any compound can be employed according to the purpose. Examples of the pH adjuster include amines such as diethanolamine and triethanolamine; hydroxides of alkali metal elements such as lithium hydroxide, sodium hydroxide and potassium hydroxide; ammonium hydroxide, quaternary ammonium hydroxide and quaternary phosphonium hydroxide; and carbonates of alkali metals such as lithium carbonate, sodium carbonate and potassium carbonate.

Examples of the anticorrosive include acid sulfite, sodium thiosulfate, ammonium thiodiglycolate, diisopropylammonium nitrite, pentaerythritol tetranitrate and dicyclohexylammonium nitrite.

Examples of the antioxidant include phenol antioxidants (including hindered phenol antioxidants), amine antioxidants, sulfur antioxidants and phosphorus antioxidants.

The refill ink of the present invention used in an ink-jet recording process is produced by dispersing or dissolving at least a colorant, a wetting agent and a surfactant, with additional constituents included according to necessity, in an aqueous solvent, and further, mixing the ingredients by means of agitation according to necessity. The dispersion can, for example, be conducted by means of a sand mill, a homogenizer, a ball mill, a paint shaker, an ultrasonic disperser, etc., and the agitation/mixing can be conducted by means of a typical agitator with an agitating blade, a magnetic stirrer, a high-speed disperser, etc.

The coloring of the ink is not particularly limited and can be suitably selected according to the purpose; for example, the ink is colored yellow, magenta, cyan or black. When recording is conducted using an ink set in which two or more of the colors are used together, it is possible to form a multicolor image, and when recording is conducted using an ink set in which all the colors are used together, it is possible to form a full-color image.

### (Ink Cartridge)

The ink cartridge of the present invention includes a container, and the refill ink of the present invention with which the container is refilled, and further includes additional members and the like suitably selected according to necessity. It is possible to prevent massive disposal of ink cartridges and thus to reduce an environmental load by refilling the ink cartridge with the refill ink of the present invention.

The ink cartridge does not have an ink absorber therein. This makes it easier to refill the ink cartridge with the refill ink.

The container is not particularly limited, and the shape, structure, size, material and the like thereof can be suitably selected according to the purpose; suitable examples thereof include a container having at least an ink bag or the like formed of an aluminum laminated film, resinous film, etc.

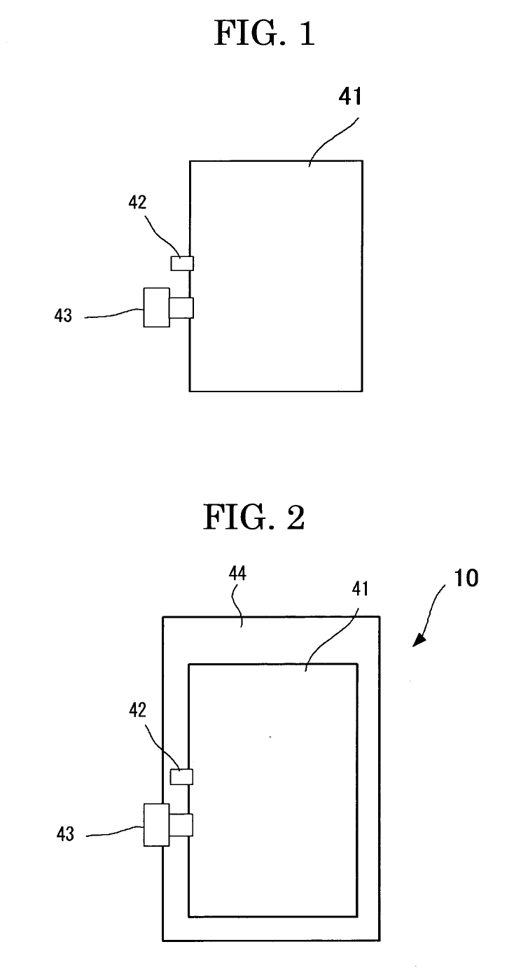

Next, the ink cartridge will be explained with reference to FIGS. 1 and 2. Here, FIG. 1 is a figure showing one example of an ink cartridge of the present invention, and FIG. 2 is a figure showing the ink cartridge 10 of FIG. 1 with the inclusion of a case (external cover).

As shown in FIG. 1, the ink cartridge 10 fills up as the refill ink flows from an ink inlet 42 into an ink bag 41, and the ink inlet 42 is closed by fusion after air is discharged. When the ink cartridge 10 is used, an ink outlet 43 formed of a rubber member is penetrated by a needle of an apparatus main body, and the ink cartridge 10 is thus installed in the apparatus.

The ink bag 41 is formed of an air-impermeable packing member such as an aluminum laminated film. As shown in FIG. 2, this ink bag 41 is normally housed in a cartridge case 44 made of plastic, and used in such a manner as to be detachably mounted on a variety of ink-jet recording apparatuses.

### EXAMPLES

The following explains Examples of the present invention; however, it should be noted that the present invention is not confined to these Examples in any way. Note that “%” means “% by mass” unless otherwise indicated.

### —Preparation of Residual Inks Nos. 1 to 4—

Printing was carried out using a black ink, a yellow ink, a magenta ink and a cyan ink, which are made exclusively for a GELJET printer (IPSiO G717 produced by Ricoh Company, Ltd.) and contained in their respective ink cartridges. Thus a residual ink No. 1 (black, BK), a residual ink No. 2 (yellow, Y), a residual ink No. 3 (magenta, M) and a residual ink No. 4 (cyan, C) remaining in the respective used ink cartridges were prepared.

### Production Example 1

### Preparation of Refill Ink No. 1 (Black Ink)

An ink composition with the following formulation was produced and sufficiently agitated at room temperature, then it was filtered through a membrane filter of 0.8 μm in average pore diameter, and refill ink No. 1 was thus produced.
carbon black (BONJET CW-1 produced by Orient Chemical Industries, Ltd.) . . . 30%
glycerin . . . 7.5%
diethylene glycol . . . 22.5%
2-pyrrolidone . . . 2%
surfactant (ECTD-3NEX produced by Nikko Chemicals Co., Ltd., polyoxyethylene alkyl ether acetate) . . . 1%
silicone antifoaming agent (KS-508 produced by Shin-Etsu Chemical Co., Ltd., self-emulsifying type) . . . 0.1%
ion-exchange water . . . the rest of the amount

### Production Example 2

### Preparation of Refill Ink No. 2 (Yellow Ink)

### —Production of Yellow Pigment Dispersion Solution 1—

The following constituents were mixed together, then the mixture was dispersed by means of a wet sand mill and centrifuged to remove coarse particles, and a yellow pigment dispersion solution 1 was thus produced.
C. I. Pigment Yellow 97 . . . 30%
polyoxyethylene oleyl ether ammonium sulfate . . . 15% by mass
ethylene glycol . . . 30% by mass
deionized water . . . the rest of the amount

### —Production of Yellow Ink—

An ink composition with the following formulation was produced and sufficiently agitated at room temperature, then it was filtered through a membrane filter of 1.2 μm in average pore diameter, and refill ink No. 2 was thus produced.
yellow pigment dispersion solution 1 . . . 10%
glycerin . . . 8%
polyethylene glycol . . . 20%
acetylene glycol-based surfactant (SURFYNOL 465 produced by Air Products and Chemicals, Inc.) . . . 1%
silicone antifoaming agent (KS-531 produced by Shin-Etsu Chemical Co., Ltd.) . . . 0.1%
ion-exchange water . . . the rest of the amount

### Production Example 3

### Preparation of Refill Ink No. 3 (Magenta Ink)

### —Production of Magenta Pigment Dispersion Solution 2—

The following constituents were mixed together, then the mixture was dispersed by means of a three-roll mill, and a magenta pigment dispersion solution 2 was thus produced.
C. I. Pigment Red 122 . . . 30%
polyoxyethylene oleyl ether ammonium sulfate . . . 15%
glycerin . . . 30%
deionized water . . . the rest of the amount

### —Production of Magenta Ink—

An ink composition with the following formulation was produced and sufficiently agitated at room temperature, then it was filtered through a membrane filter of 1.2 μm in average pore diameter, and refill ink No. 3 was thus produced.
magenta pigment dispersion solution 2 . . . 10%
glycerin . . . 8%
diethylene glycol . . . 22%
2,2,4-trimethyl-1,3-pentanediol . . . 2%
surfactant (ECTD-3NEX produced by Nikko Chemicals Co., Ltd., polyoxyethylene alkyl ether acetate) . . . 1%
silicone antifoaming agent (KS-531 produced by Shin-Etsu Chemical Co., Ltd.) . . . 0.1%
ion-exchange water . . . the rest of the amount

### Production Example 4

### Preparation of Refill Ink No. 4 (Cyan Ink)

### —Production of Cyan Pigment Dispersion Solution 3—

The following constituents were mixed together, then the mixture was dispersed by means of a wet sand mill, and a cyan pigment dispersion solution 3 was thus produced.
C. I. Pigment Blue 15:3 . . . 30%
polyoxyethylene oleyl ether ammonium sulfate . . . 15%
ethylene glycol . . . 30%
deionized water . . . the rest of the amount

### —Production of Cyan Ink—

An ink composition with the following formulation was produced and sufficiently agitated at room temperature, then it was filtered through a membrane filter of 1.2 μm in average pore diameter, and refill ink No. 4 was thus produced.
cyan pigment dispersion solution 3 . . . 15%
glycerin . . . 8%
diethylene glycol . . . 22%
2,2,4-trimethyl-1,3-pentanediol . . . 2%
surfactant (ECTD-3NEX produced by Nikko Chemicals Co., Ltd., polyoxyethylene alkyl ether acetate) . . . 1%
silicone antifoaming agent (KS-531 produced by Shin-Etsu Chemical Co., Ltd.) . . . 0.1%
ion-exchange water . . . the rest of the amount

### Production Example 5

### Preparation of Refill Ink No. 5 (Cyan Ink)

An ink composition according to the following formulation was produced and sufficiently agitated at room temperature, then it was filtered through a membrane filter of 1.2 μm in average pore diameter, and refill ink No. 5 was thus produced.
C. I. Direct Blue 199 . . . 5%
glycerin . . . 7%
diethylene glycol . . . 23%
surfactant (ECTD-3NEX produced by Nikko Chemicals Co., Ltd., polyoxyethylene alkyl ether acetate) . . . 1%
silicone antifoaming agent (KS-531 produced by Shin-Etsu Chemical Co., Ltd.) . . . 0.1%
ion-exchange water . . . the rest of the amount

### Production Example 6

### Preparation of Refill Ink No. 6 (Magenta Ink)

An ink composition according to the following formulation was produced and sufficiently agitated at room temperature, then it was filtered through a membrane filter of 1.2 μm in average pore diameter, and refill ink No. 6 was thus produced.
C. I. Direct Red 227 . . . 5%
glycerin . . . 7.5%
diethylene glycol . . . 22.5%
surfactant (ECTD-3NEX produced by Nikko Chemicals Co., Ltd., polyoxyethylene alkyl ether acetate) . . . 1%
silicone antifoaming agent (KS-531 produced by Shin-Etsu Chemical Co., Ltd.) . . . 0.1%
ion-exchange water . . . the rest of the amount

### Production Example 7

### Preparation of Refill Ink No. 7 (Black Ink)

An ink composition with the following formulation was produced and sufficiently agitated at room temperature, then it was filtered through a membrane filter of 0.8 μm in average pore diameter, and refill ink No. 7 was thus produced.
carbon black (CAB-O-JET 200 produced by Cabot Corporation) . . . 30%
glycerin . . . 8%
diethylene glycol . . . 22%
2-pyrrolidone . . . 2%
surfactant (ECTD-3NEX produced by Nikko Chemicals Co., Ltd., polyoxyethylene alkyl ether acetate) . . . 1%
silicone antifoaming agent (KS-531 produced by Shin-Etsu Chemical Co., Ltd.) . . . 0.1%
ion-exchange water . . . the rest of the amount

### Production Example 8

### Preparation of Refill Ink No. 8 (Magenta Ink)

An ink composition according to the following formulation was produced and sufficiently agitated at room temperature, then it was filtered through a membrane filter of 0.8 μm in average pore diameter, and refill ink No. 8 was thus produced.
magenta pigment dispersion solution 2 . . . 20%
glycerin . . . 10%
diethylene glycol . . . 20%
2-pyrrolidone . . . 2%
surfactant (ECTD-3NEX produced by Nikko Chemicals Co., Ltd., polyoxyethylene alkyl ether acetate) . . . 1%
diethylene glycol monobutyl ether . . . 1.5%
silicone antifoaming agent (KS-531 produced by Shin-Etsu Chemical Co., Ltd.) . . . 0.1%
ion-exchange water . . . the rest of the amount

Next, the residual inks Nos. 1 to 4 and the refill inks Nos. 1 to 8 were measured for their respective properties in the following manner. The results are shown in Table 1.

### <Measurement of the Number of Coarse Particles>

Each ink (5 μl) was measured for the number of coarse particles of 0.5 μm or greater in diameter using ACCUSIZER 780 (produced by Particle Sizing Systems, Inc.).

### <Measurement of the Amount of Divalent Metal Ions>

The amount of divalent metal ions (Ca²⁺ and Mg²⁺) contained in each ink solution prepared by filtering a ten-fold dilution of ink through a filter of 0.2 μm in average pore diameter was measured using ICA-5222 (ion chromatography) produced by DKK-TOA CORPORATION.

### <Measurement of Ink Viscosity>

The viscosity of each ink was measured at 25° C. using RL-500 produced by Toki Sangyo Co., Ltd.

### <Measurement of Volume Average Particle Diameter>

The volume average particle diameter of each ink was measured using MICROTRAC UPA150 produced by Nikkiso Co., Ltd., by using an ink solution diluted to a pigment concentration of 0.01% by mass.

TABLE 1

| | | Amount | | Average |
|---|---|---|---|---|
| | Number of | (ppm) of | | particle |
| | coarse | divalent | Viscosity | diameter |
| Ink No. | particles | metal ions | (mPa · s) | (nm) |
| Residual Ink No. 1 | 4.8 × 10⁵ | 18 | 8 | 102 |
| Residual Ink No. 2 | 7.2 × 10⁵ | 25 | 8 | 80 |
| Residual Ink No. 3 | 5.9 × 10⁵ | 20 | 8 | 140 |
| Residual Ink No. 4 | 10.5 × 10⁵ | 15 | 8 | 112 |
| Refill Ink No. 1 | 12.5 × 10⁵ | 45 | 3.8 | 150 |
| Refill Ink No. 2 | 4.2 × 10⁵ | 40 | 3.2 | 70 |
| Refill Ink No. 3 | 13.0 × 10⁵ | 45 | 3.6 | 102 |
| Refill Ink No. 4 | 8.6 × 10⁵ | 38 | 3.5 | 115 |
| Refill Ink No. 5 | 0 | 50 | 3.3 | — |
| Refill Ink No. 6 | 0 | 45 | 3.2 | — |
| Refill Ink No. 7 | 15.8 × 10⁵ | 80 | 4.1 | 98 |
| Refill Ink No. 8 | 9.2 × 10⁵ | 90 | 4.4 | 120 |

Judging from the results of Table 1, it was found that the content X of divalent metal ions in the refill ink and the content Y of divalent metal ions in the residual ink satisfied the relationship 1<X/Y≦5.

Next, Evaluations 1, 2 and 3 were carried out on mixed inks each formed by combining any of the residual inks Nos. 1 to 4 and any of the refill inks Nos. 1 to 8.

### <Evaluation 1: Measurement of the Number of Coarse Particles in Inks>

Mixed inks formed by combining the residual inks Nos. 1 to 4 and the refill inks Nos. 1 to 8 as in Table 2 at a volume ratio of 1:1 were measured for the number of coarse particles of 0.5 μm or greater in diameter immediately after mixing and also after being allowed to stand at 25° C. and at RH of 50% for 24 hours subsequent to mixing. The results are shown in Table 2.

Additionally, as to the number of coarse particles, each mixed ink (5 μl) was measured for the number of coarse particles of 0.5 μm or greater in diameter using ACCUSIZER 780 (produced by Particle Sizing Systems, Inc.).

TABLE 2

| | | | Number of | | |
|---|---|---|---|---|---|
| | | | coarse | | |
| | | | particles | Number of | |
| | Mixed ink | | immediately | coarse | |
| | Residual | Refill | after | particles after | |
| | ink | ink | mixed: A | left to stand: B | B/A |
| Example 1 | No. 1 | No. 1 | 64.9 × 10⁵ | 8.8 × 10⁶ | 1.4 |
| Example 2 | No. 2 | No. 2 | 5.7 × 10⁵ | 5.5 × 10⁵ | 1.0 |
| Example 3 | No. 3 | No. 3 | 9.45 × 10⁵ | 12.5 × 10⁵ | 1.3 |
| Example 4 | No. 4 | No. 4 | 9.65 × 10⁵ | 13.2 × 10⁵ | 1.4 |
| Example 5 | No. 3 | No. 6 | 2.95 × 10⁵ | 3.2 × 10⁵ | 1.1 |
| Example 6 | No. 4 | No. 5 | 5.25 × 10⁵ | 4.8 × 10⁵ | 0.9 |
| Comparative | No. 1 | No. 7 | 10.3 × 10⁵ | 28.3 × 10⁵ | 2.7 |
| Example 1 | | | | | |
| Comparative | No. 3 | No. 8 | 7.55 × 10⁵ | 18.4 × 10⁵ | 2.4 |
| Example 2 | | | | | |

### <Evaluation 2: Evaluation of Storage Stability of Mixed Inks>

Mixed inks each formed by combining any of the residual inks Nos. 1 to 4 and any of the refill inks Nos. 1 to 8 as shown in Tables 3 and 4 at a volume ratio 1:1 were stored for one week at 25° C. and at RH of 50% and also at 50° C. and at RH of 30% and measured for their viscosities and average particle diameters before and after the storage. The viscosity of each mixed ink was measured at 25° C. using RL-500 produced by Toki Sangyo Co., Ltd. The volume average particle diameter of each mixed ink was measured using a MICROTRAC UPA150 produced by Nikkiso Co., Ltd., using a mixed ink solution diluted to a pigment concentration of 0.01% by mass. The results are shown in Tables 3 and 4.

TABLE 3

| | Mixed ink | | Viscosity | Viscosity (mPa · s) | Viscosity (mPa · s) | |
|---|---|---|---|---|---|---|
| | Residual | Refill | (mPa · s) before | after stored at 25° C. | after stored at 50° C. | |
| | ink | ink | stored: C | for one week: D | for one week | D/C |
| Example 1 | No. 1 | No. 1 | 5.3 | 5.5 | 5.6 | 1.04 |
| Example 2 | No. 2 | No. 2 | 5.1 | 5.1 | 5.2 | 1.0 |
| Example 3 | No. 3 | No. 3 | 5.5 | 5.5 | 5.3 | 1.0 |
| Example 4 | No. 4 | No. 4 | 5.7 | 5.7 | 5.8 | 1.0 |
| Example 5 | No. 3 | No. 6 | 4.8 | 4.7 | 4.9 | 0.98 |
| Example 6 | No. 4 | No. 5 | 5.2 | 5.3 | 5.5 | 1.02 |
| Comparative | No. 1 | No. 7 | 6.3 | 13.5 | 25.5 | 2.1 |
| Example 1 | | | | | | |
| Comparative | No. 3 | No. 8 | 6.6 | 15.5 | 32.8 | 2.35 |
| Example 2 | | | | | | |

TABLE 4

| | | | | Average particle | Average particle | |
|---|---|---|---|---|---|---|
| | Mixed ink | | Average particle | diameter (nm) after | diameter (nm) after | |
| | Residual | Refill | diameter (nm) | stored at 25° C. for | stored at 50° C. for | |
| | ink | ink | before stored: E | one week: F | one week | F/E |
| Example 1 | No. 1 | No. 1 | 132 | 138 | 135 | 1.05 |
| Example 2 | No. 2 | No. 2 | 80 | 75 | 78 | 0.93 |
| Example 3 | No. 3 | No. 3 | 125 | 132 | 128 | 1.06 |
| Example 4 | No. 4 | No. 4 | 115 | 113 | 122 | 0.98 |
| Example 5 | No. 3 | No. 6 | 138 | 135 | 132 | 0.98 |
| Example 6 | No. 4 | No. 5 | 110 | 105 | 108 | 0.95 |
| Comparative | No. 1 | No. 7 | 105 | 180 | 254 | 1.71 |
| Example 1 | | | | | | |
| Comparative | No. 3 | No. 8 | 126 | 202 | 323 | 1.6 |
| Example 2 | | | | | | |

### <Evaluation 3: Evaluation of Jet Stability>

An continuous printing evaluation was carried out on mixed inks each formed by combining any of the residual inks Nos. 1 to 4 and any of the refill inks Nos. 1 to 8 as shown in Table at a volume ratio of 1:1.

Using a GELJET printer (IPSiO G717 produced by Ricoh Company, Ltd.) as an evaluation device, continuous printing was conducted for a chart provided with solid images of respective colors by discharging corresponding color inks in equal amounts per printing, followed by determination of the number of print sheets in which no image blur was generated. The numbers of sheets that succeeded in continuous printing with no image blur are shown in Table 5.

TABLE 5

| | Mixed ink | | Number of sheets that |
|---|---|---|---|
| | Residual | Refill | succeeded in continuous |
| | ink | ink | printing with no image blur |
| Example 1 | No. 1 | No. 1 | 80 |
| Example 2 | No. 2 | No. 2 | 95 |
| Example 3 | No. 3 | No. 3 | 75 |
| Example 4 | No. 4 | No. 4 | 78 |
| Example 5 | No. 3 | No. 6 | 60 |
| Example 6 | No. 4 | No. 5 | 65 |
| Comparative Example 1 | No. 1 | No. 7 | 3 |
| Comparative Example 2 | No. 3 | No. 8 | 12 |

According to the results in Tables 2 to 5, the inks of Examples 1 to 6, whose B/A values in Evaluation 1 were 2 or less, proved favorable in terms of both storage stability in Evaluation 2 and jet stability in Evaluation 3.

Meanwhile, the inks of Comparative Examples 1 and 2, whose B/A values in Evaluation 1 were greater than 2, proved unfavorable in terms of both storage stability in Evaluation 2 and jet stability in Evaluation 3.

### INDUSTRIAL APPLICABILITY

The refill ink of the present invention is excellent in jet stability and storage stability, enables high-quality image recording, and enables a used ink cartridge to be reused as the used ink cartridge is refilled with the refill ink and to be thus prevented from being discarded.

1. A refill ink with which a used ink cartridge is to be refilled, comprising:
a colorant,
a wetting agent, and
a surfactant,
wherein in a mixed ink formed by mixing a residual ink remaining in the used ink cartridge and the refill ink at a volume ratio (residual ink:refill ink) of 1:1, the number A of coarse particles of 0.5 μm or greater in diameter measured immediately after the mixing and the number B of coarse particles of 0.5 μm or greater in diameter measured after the mixed ink has been left to stand at 25° C. and at RH of 50% for 24 hours satisfy the relationship B/A≦2.

2. The refill ink according to claim 1, wherein the viscosity (C) of the mixed ink at 25° C. before being stored and the viscosity (D) of the mixed ink at 25° C. after being stored at 25° C. and at RH of 50% for one week satisfy the relationship D/C≦2.

3. The refill ink according to claim 1, wherein the volume average particle diameter (E) of the mixed ink before being stored and the volume average particle diameter (F) of the mixed ink after being stored at 25° C. and at RH of 50% for one week satisfy the relationship F/E≦1.5.

4. The refill ink according to claim 1, wherein the content X of divalent metal ions in the refill ink and the content Y of divalent metal ions in the residual ink satisfy the relationship 1<X/Y≦5.

5. An ink cartridge comprising:
a container, and
a refill ink with which a used ink cartridge is to be refilled, that is for use in the container and comprises a colorant, a wetting agent and a surfactant,
wherein in a mixed ink formed by mixing a residual ink remaining in the used ink cartridge and the refill ink at a volume ratio (residual ink:refill ink) of 1:1, the number A of coarse particles of 0.5 μm or greater in diameter measured immediately after the mixing and the number B of coarse particles of 0.5 μm or greater in diameter measured after the mixed ink has been left to stand at 25° C. and at RH of 50% for 24 hours satisfy the relationship B/A≦2.

6. The ink cartridge according to claim 5, wherein the ink cartridge comprises no ink absorber therein.
